(19) United States
(12) Patent Application Publication
(10) Pub. No.: US 2025/0338181 A1
(43) Pub. Date: Oct. 30, 2025

(54) DETECTION OF RADIO ACCESS TECHNOLOGY HANDOVER LOOPS AND AVOIDANCE

(71) Applicant: Samsung Electronics Co., Ltd., Suwon-si (KR)

(72) Inventors: Kushagra Bhatnagar, Bridgewater, NJ (US); Mohan Reddy Duggi, Basking Ridge, NJ (US)

(21) Appl. No.: 18/646,417

(22) Filed: Apr. 25, 2024

(51) Int. Cl. H04W 36/00; H04W 36/14; H04W 36/30

(52) U.S. Cl. CPC H04W 36/0066; H04W 36/1446; H04W 36/302

(57) ABSTRACT

A method includes initiating a communication session by an electronic device using a first radio access technology (RAT). The method also includes receiving a handover (EPS fallback) request based on a determination that the communication session is unsupported by the first RAT. The method further includes switching to a second RAT based on the handover request. In addition, the method includes blacklisting use of the first RAT for at least a portion of the communication session. The blacklisting of the first RAT can include disabling a mode associated with the first RAT for a duration of the communication session. The blacklisting of the first RAT can also include starting a timer indicating a duration in which handover to the first RAT is prevented.

### TECHNICAL FIELD

This disclosure relates generally to telecommunications systems. More specifically, this disclosure relates to detection of radio access technology handover loops and avoidance.

### BACKGROUND

Fifth Generation (5G) New Radio (NR) is the fifth generation of cellular technology that has been deployed. 5G operates on higher frequency bands but with a lower coverage footprint compared to Fourth Generation (4G) Long-Term Evolution (LTE). Among many services which 5G offers, one of the most common is voice services, such as Voice over NR (VONR). Due to 5G having a lower coverage footprint and also because not all devices and not all Next Generation Radio Access Networks (NG-RANs) are capable of providing voice services, 5G-compatible devices also often perform Evolved Packet System (EPS) fallback, such as handovers, to 4G voice, or Voice over LTE (VOLTE), for providing seamless voice services to users. Additionally, with more and more wireless network technologies supporting voice services, such as VONR, VOLTE, and Voice over WiFi (VoWiFi), there are also increased chances of handovers between these technologies for seamless voice support. However, handover operations are costly and utilize a large amount of network and device resources, and problems with handover efficiency can be encountered, such as entering handover loops in which a device will ping-pong between wireless network technologies.

### SUMMARY

This disclosure relates to detection of radio access technology handover loops and avoidance.

In a first embodiment, a method includes initiating a communication session by an electronic device using a first radio access technology (RAT). The method also includes receiving a handover request based on a determination that the communication session is unsupported by the first RAT. The method further includes switching to a second RAT based on the handover request. In addition, the method includes blacklisting use of the first RAT for at least a portion of the communication session.

In a second embodiment, an electronic device includes at least one processing device configured to initiate a communication session using a first RAT. The at least one processing device is also configured to receive a handover request based on a determination that the communication session is unsupported by the first RAT. The at least one processing device is further configured to switch to a second RAT based on the handover request. In addition, the at least one processing device is configured to blacklist use of the first RAT for at least a portion of the communication session.

In a third embodiment, a non-transitory machine readable medium contains instructions that when executed cause at least one processor of an electronic device to initiate a communication session using a first RAT. The non-transitory machine-readable medium also contains instructions that when executed cause the at least one processor to receive a handover request based on a determination that the communication session is unsupported by the first RAT. The non-transitory machine-readable medium further contains instructions that when executed cause the at least one processor to switch to a second RAT based on the handover request. In addition, the non-transitory machine-readable medium contains instructions that when executed cause the at least one processor to blacklist use of the first RAT for at least a portion of the communication session.

In various embodiments, the handover request is an Evolved Packet System (EPS) fallback request.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example wireless network in accordance with this disclosure;

FIG. 2 illustrates an example base station in accordance with this disclosure;

FIG. 3 illustrates an example electronic device in accordance with this disclosure;

FIGS. 4A and 4B illustrate an example handover loop avoidance process in accordance with this disclosure;

FIGS. 5A and 5B illustrate another example handover loop avoidance process in accordance with this disclosure; and

FIG. 6 illustrates an example method for handover loop avoidance in accordance with this disclosure.

### DETAILED DESCRIPTION

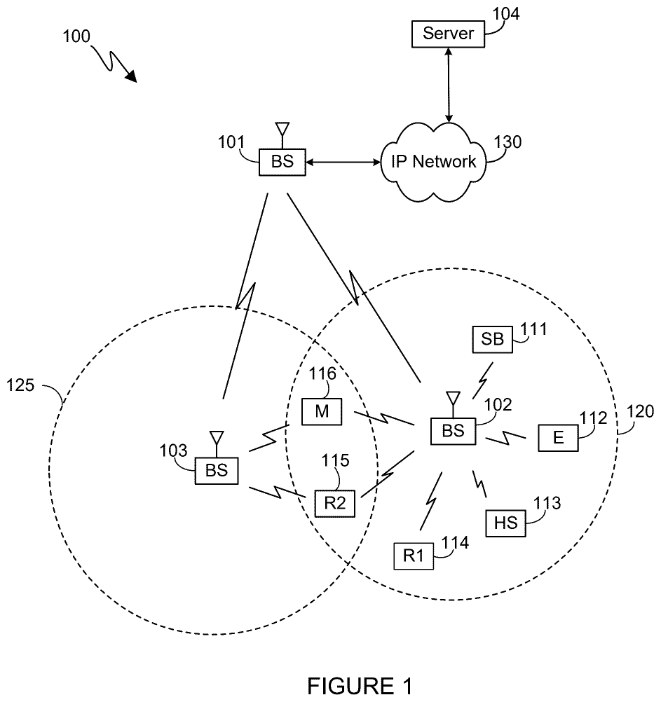

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, Fifth Generation (5G) New Radio (NR) is the fifth generation of cellular technology that has been deployed. 5G operates on higher frequency bands but with a lower coverage footprint compared to Fourth Generation (4G) Long-Term Evolution (LTE). Among many services which 5G offers, one of the most common is voice services, such as Voice over NR (VoNR). Due to 5G having a lower coverage footprint and also because not all devices and not all Next Generation Radio Access Networks (NG-RANs) are capable of providing voice services, 5G-compatible devices also often perform Evolved Packet System (EPS) fallback, such as handovers, to 4G voice, or Voice over LTE (VOLTE), for providing seamless voice services to users. Additionally, with more and more wireless network technologies supporting voice services, such as VONR, VOLTE, and Voice over WiFi (VoWiFi), there are also increased chances of handovers between these technologies for seamless voice support. However, handover operations are costly and utilize a large amount of network and device resources, and problems with handover efficiency can be encountered, such as entering handover loops in which a device will ping-pong between wireless network technologies.

This disclosure provides for detection of radio access technology handover loops and processes executable by user devices that provide an intelligent mechanism in which the user devices refrain from performing unnecessary handovers and avoid entering handover loops. As described in this disclosure, for example, in various embodiments, when a device switches from a first radio access technology (RAT) to a second RAT, the device can blacklist use of the first RAT, such as for at least a portion of a communication session. In various embodiments of this disclosure, the device can perform a handover to a third RAT and can start a timer indicating a duration during which handover to the first RAT is prevented. In some embodiments, in response to an expiry of the timer, the device disables a mode associated with the first RAT and measures the signal strength of the second RAT. If the measured signal strength of the second RAT is above a first threshold, the device continues disabling of the mode associated with the first RAT and performs a handover from a third RAT back to the second RAT. If the measured signal strength of the second RAT is below the first threshold, the device can reenable the mode associated with the first RAT and restart the timer. In this way, it is possible to reduce or avoid performing unnecessary handovers and avoid entering handover loops.

FIG. 1 illustrates an example wireless network 100 in accordance with this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a base station (BS) 101, a BS 102, and a BS 103. The BS 101 communicates with the BS 102 and the BS 103. The BS 101 also communicates with at least one Internet Protocol (IP) network 130, such as the Internet, a proprietary IP network, or another data network.

The BS 102 provides wireless broadband access to the network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R1); a UE 115, which may be located in a second residence (R2); and a UE 116, which may be a mobile device (M) like a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. As the UE 115 and the UE 116 are within both coverage areas 120, 125, handovers may occur to switch either one of the UE 115 and the UE 116 to using one or the other of the BSs 102, 103. In some embodiments, one or more of the BSs 101-103 may communicate with each other and with the UEs 111-116 using 5G, LTE, LTE Advanced (LTE-A), WiMAX, WiFi, or other wireless communication techniques.

Depending on the network type, other well-known terms may be used instead of “base station” or “BS,” such as node B, evolved node B (“eNodeB” or “eNB”), a 5G node B (“gNodeB” or “gNB”), or “access point.” For the sake of convenience, the terms “base station” and/or “BS” are used in this disclosure to refer to network infrastructure components that provide wireless access to remote terminals. Also, depending on the network type, other well-known terms may be used instead of “user equipment” or “UE,” such as “mobile station” (or “MS”), “subscriber station” (or “SS”), “remote terminal,” “wireless terminal,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extent of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

Although FIG. 1 illustrates one example of a wireless network 100, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BS 101, 102, and/or 103 could provide access to other or additional external networks, such as external telephone networks or other types of data networks.

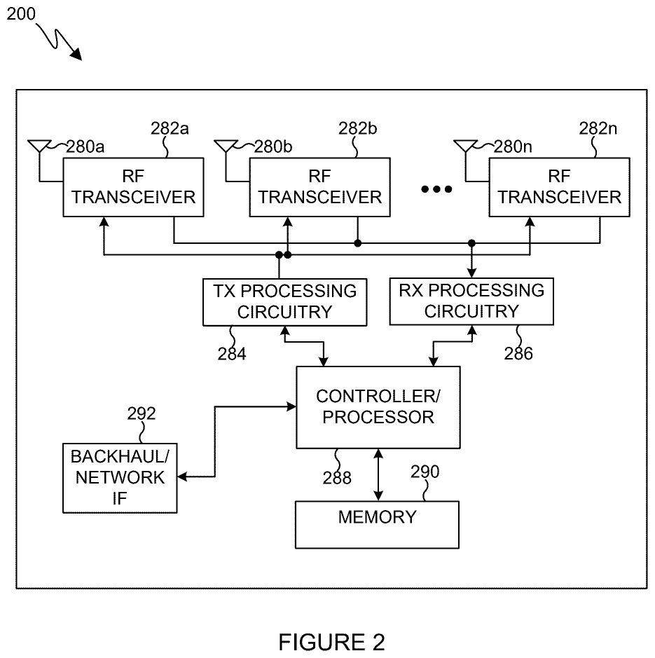

FIG. 2 illustrates an example base station (BS) 200 in accordance with this disclosure. The embodiment of the BS 200 illustrated in FIG. 2 is for illustration only, and the BSs 101, 102 and/or 103 of FIG. 1 could have the same or similar configuration. However, BSs come in a wide variety of configurations, and FIG. 2 does not limit the scope of this disclosure to any particular implementation of a BS.

As shown in FIG. 2, the BS 200 includes multiple antennas 280a-280n, multiple radio frequency (RF) transceivers 282a-282n, transmit (TX or Tx) processing circuitry 284, and receive (RX or Rx) processing circuitry 286. The BS 200 also includes a controller/processor 288, a memory 290, and a backhaul or network interface 292.

The RF transceivers 282a-282n receive, from the antennas 280a-280n, incoming RF signals, such as signals transmitted by UEs in the network 100. The RF transceivers 282a-282n down-convert the incoming RF signals to generate IF or baseband signals. The IF or baseband signals are sent to the RX processing circuitry 286, which generates processed baseband signals by filtering, decoding, and/or digitizing the baseband or IF signals. The RX processing circuitry 286 transmits the processed baseband signals to the controller/processor 288 for further processing.

The TX processing circuitry 284 receives analog or digital data (such as voice data, web data, e-mail, or interactive video game data) from the controller/processor 288. The TX processing circuitry 284 encodes, multiplexes, and/or digitizes the outgoing baseband data to generate processed baseband or IF signals. The RF transceivers 282a-282n receive the outgoing processed baseband or IF signals from the TX processing circuitry 284 and up-converts the baseband or IF signals to RF signals that are transmitted via the antennas 280a-280n.

The controller/processor 288 can include one or more processors or other processing devices that control the overall operation of the BS 200. For example, the controller/processor 288 could control the reception of forward channel signals and the transmission of reverse channel signals by the RF transceivers 282a-282n, the RX processing circuitry 286, and the TX processing circuitry 284 in accordance with well-known principles. The controller/processor 288 could support additional functions as well, such as more advanced wireless communication functions and/or processes described in further detail below. For instance, the controller/processor 288 could support beam forming or directional routing operations in which outgoing signals from multiple antennas 280a-280n are weighted differently to effectively steer the outgoing signals in a desired direction. Any of a wide variety of other functions could be supported in the BS 200 by the controller/processor 288. In some embodiments, the controller/processor 288 includes at least one microprocessor or microcontroller.

The controller/processor 288 is also capable of executing programs and other processes resident in the memory 290, such as a basic operating system (OS). The controller/processor 288 can move data into or out of the memory 290 as required by an executing process.

The controller/processor 288 is also coupled to the backhaul or network interface 292. The backhaul or network interface 292 allows the BS 100 to communicate with other devices or systems over a backhaul connection or over a network. The interface 292 could support communications over any suitable wired or wireless connection(s). For example, when the BS 200 is implemented as part of a cellular communication system (such as one supporting 6G, 5G, LTE, or LTE-A), the interface 292 could allow the BS 200 to communicate with other BSs over a wired or wireless backhaul connection. When the BS 200 is implemented as an access point, the interface 292 could allow the BS 200 to communicate over a wired or wireless local area network or over a wired or wireless connection to a larger network (such as the Internet). The interface 292 includes any suitable structure supporting communications over a wired or wireless connection, such as an Ethernet or RF transceiver.

The memory 290 is coupled to the controller/processor 288. Part of the memory 290 could include a random access memory (RAM), and another part of the memory 290 could include a Flash memory or other read only memory (ROM).

As described in more detail below, base stations in a networked computing system such as the network 100 can be used to initiate a communication session with an electronic device using a radio access technology (RAT) associated with the base station. In some embodiments, a handover request can be sent to the electronic device via one of the base stations based on a determination that a first RAT is unsupported. Also, in some embodiments, a second RAT can be switched to based on the handover request. Further, in some embodiments, use of the first RAT can be blacklisted for at least a portion of the communication session.

Although FIG. 2 illustrates one example of BS 200, various changes may be made to FIG. 2. For example, the BS 200 could include any number of each component shown in FIG. 2. As a particular example, an access point could include a number of interfaces 292, and the controller/processor 288 could support routing functions to route data between different network addresses. As another particular example, while shown as including a single instance of TX processing circuitry 284 and a single instance of RX processing circuitry 286, the BS 102 could include multiple instances of each (such as one per RF transceiver). Also, various components in FIG. 2 could be combined, further subdivided, or omitted and additional components could be added according to particular needs.

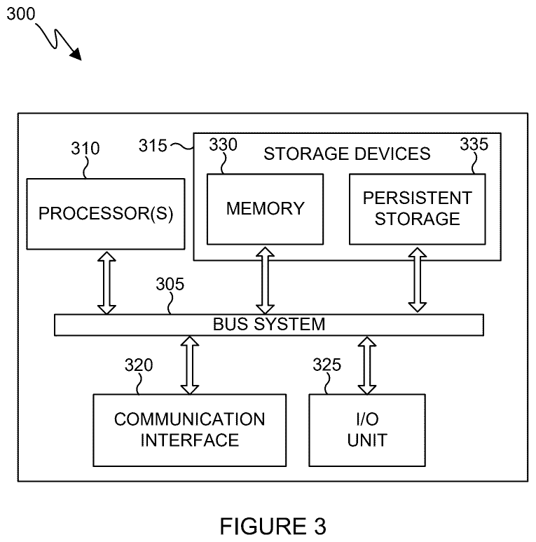

FIG. 3 illustrates an example electronic device 300 in accordance with this disclosure. In some embodiments, the electronic device 300 is a user equipment implemented as a mobile device, which can represent one of the UEs 111, 112, 113, 114, 115 or 116 in FIG. 1. However, UEs come in a wide variety of configurations, and FIG. 3 does not limit the scope of this disclosure to any particular implementation of a UE.

As shown in FIG. 3, the electronic device 300 includes a bus system 305, which supports communication between at least one processing device 310, at least one storage device 315, at least one communications unit 320, and at least one input/output (I/O) unit 325.

The processing device 310 executes instructions that may be loaded into a memory 330. The processing device 310 may include any suitable number(s) and type(s) of processors or other devices in any suitable arrangement. Example types of processing devices 310 include microprocessors, microcontrollers, digital signal processors, field programmable gate arrays, application specific integrated circuits, and discrete circuitry.

The memory 330 and a persistent storage 335 are examples of storage devices 315, which represent any structure(s) capable of storing and facilitating retrieval of information (such as data, program code, and/or other suitable information on a temporary or permanent basis). The memory 330 may represent a random access memory or any other suitable volatile or non-volatile storage device(s). The persistent storage 335 may contain one or more components or devices supporting longer-term storage of data, such as a ready only memory, hard drive, Flash memory, or optical disc.

The communications unit 320 supports communications with other systems or devices. For example, the communications unit 320 could include a network interface card or a wireless transceiver facilitating communications over the network 130. The communications unit 320 may support communications through any suitable physical or wireless communication link(s).

The I/O unit 325 allows for input and output of data. For example, the I/O unit 325 may provide a connection for user input through a keyboard, mouse, keypad, touchscreen, or other suitable input device. The I/O unit 325 may also send output to a display, printer, or other suitable output device.

As described in more detail below, the electronic device 300 can initiate a communication session using a radio access technology (RAT) associated with a base station. In some embodiments, a handover request can be received by the electronic device 300 based on a determination that a first RAT is unsupported. Also, in some embodiments, the electronic device 300 can switch to using a second RAT based on the handover request. Further, in some embodiments, the electronic device 300 can blacklist use of the first RAT for at least a portion of the communication session.

Although FIG. 3 illustrates an example of an electronic device 300 in a wireless system including a plurality of such electronics devices, such as UEs 111, 112, 113, 114, 115 or 116 in FIG. 1, various changes may be made to FIG. 3. For example, various components in FIG. 3 can be combined, further subdivided, or omitted and additional components could be added according to particular needs. In addition, as with computing and communication networks, electronic devices can come in a wide variety of configurations, and FIG. 3 does not limit this disclosure to any particular electronic device.

As described above, with more and more network technologies supporting voice services (such as VoNR, VOLTE, and VoWiFi), there is also an increased chance of handovers occurring between these technologies. Although handovers between these technologies can be beneficial, such as to provide seamless voice support, problems can arise. Consider the example scenario below.
1. A device (such as a UE) is in an area where a 5G (NR) signal is strong, an LTE signal is weak, and a WiFi signal is good. The device is connected to WiFi.
2. The 5G network does not support VONR in the area serving the device. Initially, the device is in an idle mode, and calling preferences are set to use the cellular network(s). Therefore, an IP Multimedia Subsystem (IMS) is registered over the 5G network.
3. A user of the device initiates a voice call. Since the 5G network does not support VoNR, the device performs EPS fallback to the 4G (LTE) network, and the voice call connects as a VOLTE call.
4. As soon as the voice call connects over 4G, the device starts scanning LTE signal strength.
5. As the LTE signal is weak in that area, the device is connected to WiFi, and VoWiFi is turned on, the device performs a VOLTE-to-VoWiFi handover of the voice call in order to provide better call quality to the user using the WiFi network.
6. After the call handover to VoWiFi, the device starts scanning 5G signal strength.
7. As the 5G signal is strong and calling preferences are set to use the cellular network(s), the device performs a VoWiFi to VoNR handover, bringing the process back to step #3 above.
8. This causes steps #3 and #7, which include three handovers (VONR->VOLTE->VoWiFi->VONR), to keep repeating in a loop for the entire duration of the call.

In the above scenario, the device would perform multiple handovers during the call, thereby creating a large amount of network resource utilization, as well as an increase in signaling traffic between the device and the network. These frequent handovers might also lead to the call being dropped eventually. Embodiments of this disclosure address these issues by providing mechanisms for mitigating frequent handovers and avoiding entering handover loops.

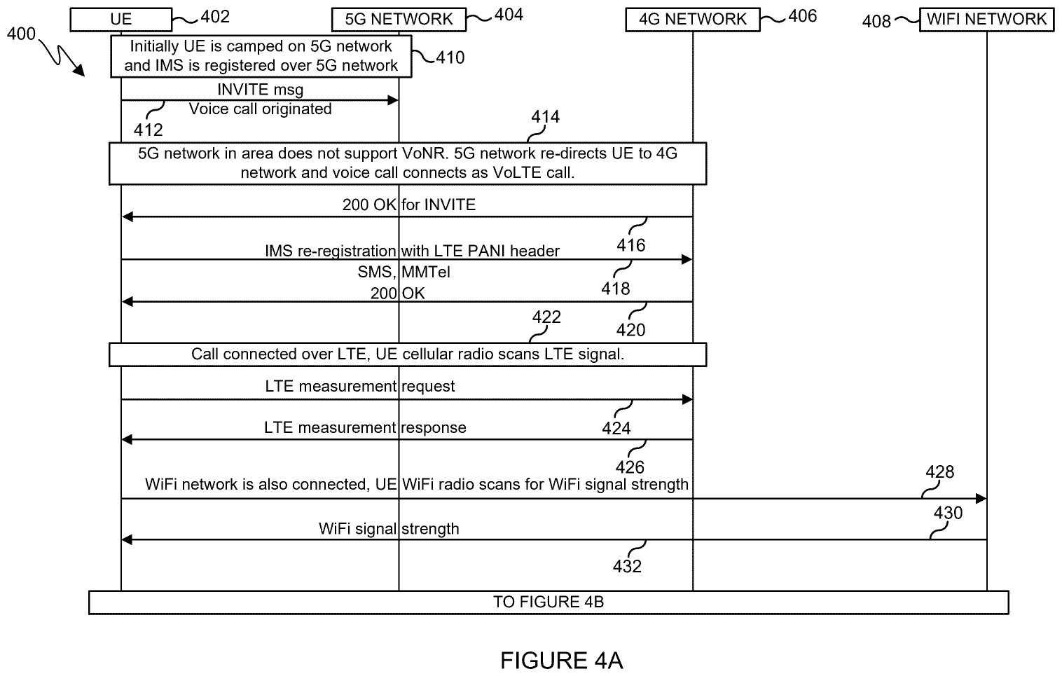

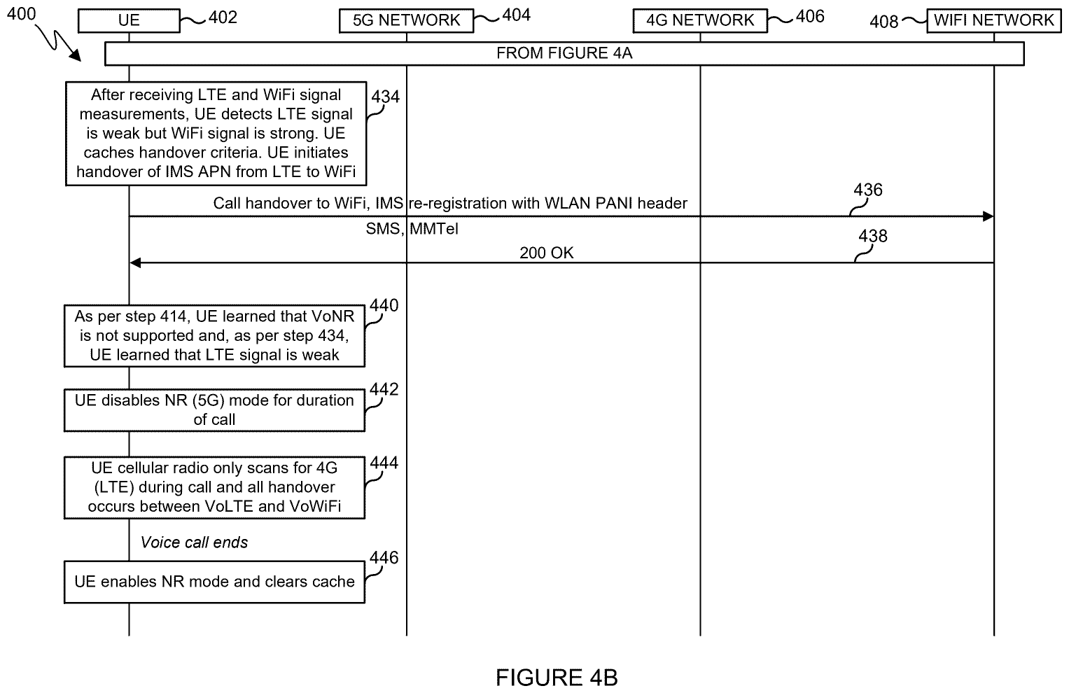

FIGS. 4A and 4B illustrate an example handover loop avoidance process 400 in accordance with this disclosure. For ease of explanation, the process 400 may be described as involving the use of a UE, such as the electronic device 300, in the wireless network 100 of FIG. 1. However, the process 400 may be used with any other suitable electronic device and in any other suitable system(s) and/or network(s).

As shown in FIGS. 4A and 4B, the process 400 involves a UE 402, a 5G network 404, a 4G network 406, and a WiFi network 408. For example, the UE 402 may be any of UEs 111, 112, 113, 114, 115 or 116 in FIG. 1 and may have the structure of the electronic device 300 in FIG. 3. The 5G network 404, the 4G network 406, and the WiFi network 408 may each include one or more BSs 101, 102 or 103 in FIG. 1, each of which may have the structure of the BS 200 illustrated in FIG. 2.

As shown in FIG. 4A, at step 410, the UE 402 is initially camped on the 5G network 404, and the IMS is registered over the 5G network 404. At step 412, a voice call is originated using the 5G network, such as the UE 402 sending an INVITE message over the 5G network 404. At step 414, it is determined that the 5G network 404 does not support VONR, at least in the area in which the UE 402 is currently operating. In response, the 5G network 404 redirects the UE 402 to the 4G network 406, and the voice call continues as a VOLTE call.

At step 416, to complete the establishment of the VOLTE call, the 4G network 406 sends to the UE 402 a confirmatory response to the INVITE message previously sent by the UE 402. At step 418, a message, such as a message having a P-Access-Network-Info (PANI) header, is sent from the UE 402 to the 4G network 406 to re-register the IMS over the 4G network 406 using a technology such as short message service (SMS) or multi-media telephone (MMTel). At step 420, a confirmatory message is sent from the 4G network 406 to the UE 402 in response to the IMS re-registration message sent by the UE 402.

At step 422, the call is connected over LTE via the 4G network 406, and the UE 402 begins scanning the LTE signal. At step 424, the UE 402 sends an LTE measurement request over the 4G network 406. At step 426, the 4G network 406 provides to the UE 402 an LTE measurement response. The LTE measurement response can include one or more characteristics of the LTE signal, such as a reference signal received power (RSRP) metric, a reference signal received quality (RSRQ) metric, a server name indication (SNI), etc. At step 428, a WiFi radio of the UE 402 also scans the WiFi signal strength for the connected WiFi network 408. At step 432, the UE 402 receives a WiFi signal strength measurement response from the WiFi network 408. The WiFi signal strength measurement response can include one or more characteristics of the WiFi signal, such as a received signal strength indicator (RSSI) metric, etc.

As shown in FIG. 4B, at step 434, after receiving the LTE and WiFi signal measurements, the UE 402 detects that the LTE signal is weak and the WiFi signal is strong. This can include the UE 402 comparing the LTE signal strength to an LTE signal strength threshold and comparing the WiFi signal strength to a WiFi signal strength threshold. The UE 402 also caches cellular and WiFi handover criteria, which can include the characteristics of the LTE signal and the characteristics of the WiFi signal received at steps 426 and 432.

Based on the handover criteria, the UE 402 initiates a handover of the IMS access point name (APN) from LTE to WiFi. At step 436, the UE 402 performs the call handover to WiFi, sending an IMS re-registration request with a WLAN PANI header to the WiFi network 408. At step 438, the UE 402 receives a confirmatory response from the WiFi network 408.

At step 440, the UE 402 identifies that it has learned, as per step 414 and such as based on the cached handover criteria, that VoNR is not supported by the 5G network 404. The UE 402 also identifies that it has learned, as per step 434 and such as based on the cached handover criteria, that the LTE signal for the 4G network 406 is weak. Based on this, at step 442, the UE 402 disables the NR (5G) mode for the duration of the voice call. In this way, the UE 402 avoids the issues of entering a loop where the UE 402 performs a handover from VoWiFi back to VoNR, which then causes, because VoNR is not currently supported, repeated switching back to VOLTE and VoWiFi. Rather, since UE 402 disables the NR mode at step 442, the UE 402 can continue with VoWiFi or switch between just VOLTE and VoWiFi depending on continued detected signal strengths. For example, at step 444, the UE 402 scans for only LTE signal strength during the call and only performs handovers between VOLTE and VoWiFi depending the detected signal strength of each. It will be understood that the LTE and

WiFi signal strengths may change for a variety of reasons, such as if the user of the UE 402 is moving around in a location or moving to different locations.

When the voice call ends, at step 446, the UE 402 re-enables the NR mode and clears the cache of handover criteria. The process 400 can be repeated for other call sessions. In this way, the process 400 provides for repeated handover avoidance by using dynamic configuration of blacklisting policies for RAT selection via the caching of cellular and WiFi handover criteria and via blacklisting fallback to the origin RAT (such as 5G) to avoid ping-ponging between cellular and WiFi networks. This reduces use of network resources and improves call quality, such as by reducing the likelihood of the call being dropped by avoiding switching to a network that does not support the call (like the 5G network 404).

Although FIGS. 4A and 4B illustrate one example of a handover loop avoidance process 400, various changes may be made to FIGS. 4A and 4B. For example, various components and functions in FIGS. 4A and 4B may be combined, further subdivided, replicated, or rearranged according to particular needs. Also, one or more additional components and functions may be included if needed or desired. In addition, while shown as a series of steps, various steps in FIGS. 4A and 4B could overlap, occur in parallel, occur in a different order, or occur any number of times (including zero times).

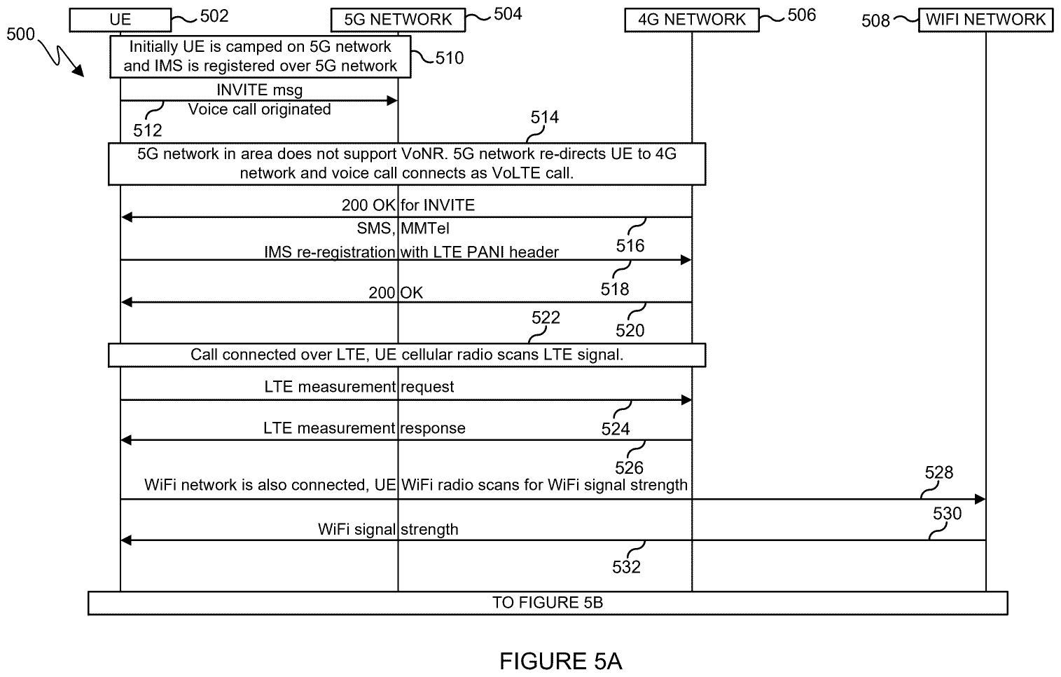

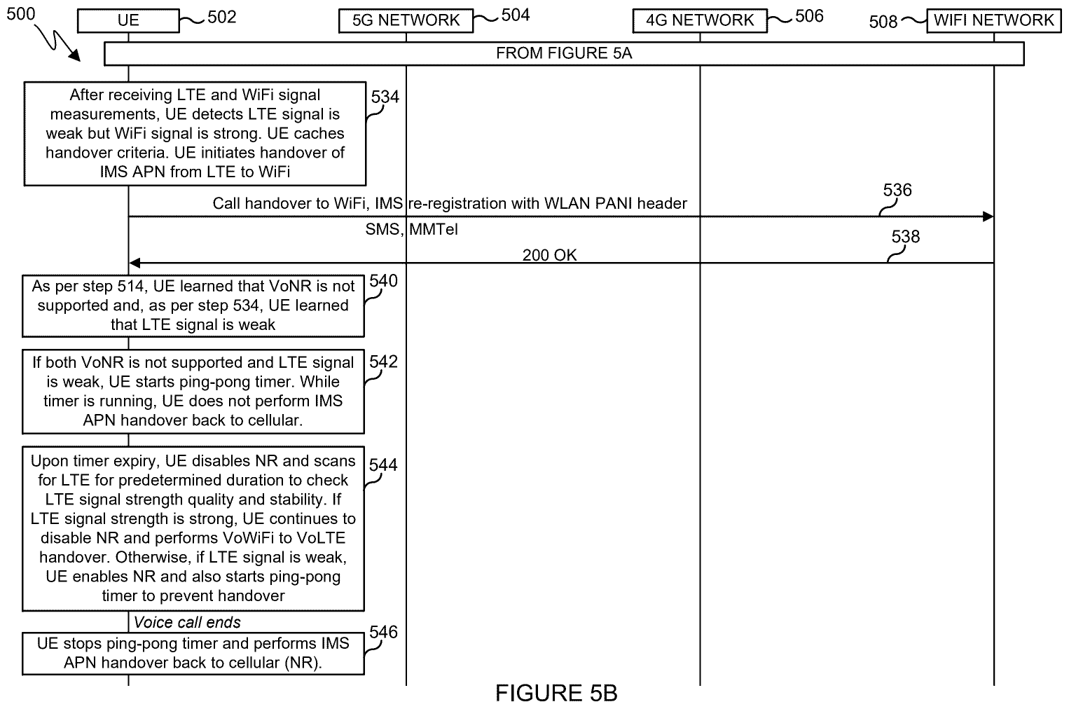

FIGS. 5A and 5B illustrate another example handover loop avoidance process 500 in accordance with this disclosure. For ease of explanation, the process 500 may be described as involving the use of a UE, such as the electronic device 300, in the wireless network 100 of FIG. 1. However, the process 500 may be used with any other suitable electronic device and in any other suitable system(s) and/or network(s).

As shown in FIGS. 5A and 5B, the process 500 involves a UE 502, a 5G network 504, a 4G network 506, and a WiFi network 508. For example, the UE 502 may be any of UEs 111, 112, 113, 114, 115 or 116 in FIG. 1 and may have the structure of the electronic device 300 in FIG. 3. The 5G network 504, the 4G network 506, and the WiFi network 508 may each include one or more BSs 101, 102 or 103 in FIG. 1, each of which may have the structure of the BS 200 illustrated in FIG. 2.

As shown in FIGS. 5A and 5B, the process 500 is initially similar to the process 400 described with respect to FIGS. 4A and 4B. At step 510, the UE 502 is initially camped on the 5G network 504, and the IMS is registered over the 5G network 504. At step 512, a voice call is originated using the 5G network, such as the UE 502 sending an INVITE message over the 5G network 504. At step 514, it is determined that the 5G network 504 does not support VONR, at least in the area in which the UE 502 is currently operating. In response, the 5G network 504 redirects the UE 502 to the 4G network 506, and the voice call continues as a VOLTE call.

At step 516, to complete the establishment of the VOLTE call, the 4G network 506 sends to the UE 502 a confirmatory response to the INVITE message previously sent by the UE 502. At step 518, a message, such as a message having a PANI header, is sent from the UE 502 to the 4G network 506 to re-register the IMS over the 4G network 506 using a technology such as SMS or MMTel. At step 520, a confirmatory message is sent from the 4G network 506 to the UE 502 in response to the IMS re-registration message sent by the UE 502.

At step 522, the call is connected over LTE via the 4G network 506, and the UE 502 begins scanning the LTE signal. At step 524, the UE 502 sends an LTE measurement request over the 4G network 506. At step 526, the 4G network 506 provides to the UE 502 an LTE measurement response. The LTE measurement response can include one or more characteristics of the LTE signal, such as a RSRP metric, a RSRQ metric, an SNI, etc. At step 528, a WiFi radio of the UE 502 also scans the WiFi signal strength for the connected WiFi network 508. At step 532, the UE 502 receives a WiFi signal strength measurement response from the WiFi network 508. The WiFi signal strength measurement response can include one or more characteristics of the WiFi signal, such as a RSSI metric, etc.

As shown in FIG. 5B, at step 534, after receiving the LTE and WiFi signal measurements, the UE 502 detects that the LTE signal is weak and the WiFi signal is strong. This can include the UE 502 comparing the LTE signal strength to an LTE signal strength threshold and comparing the WiFi signal strength to a WiFi signal strength threshold. The UE 502 also caches cellular and WiFi handover criteria, which can include the characteristics of the LTE signal and the characteristics of the WiFi signal received at steps 526 and 532.

Based on the handover criteria, the UE 502 initiates a handover of the IMS APN from LTE to WiFi. At step 536, the UE 502 performs the call handover to WiFi, sending an IMS re-registration request with a WLAN PANI header to the WiFi network 508. At step 538, the UE 502 receives a confirmatory response from the WiFi network 508.

At step 540, the UE 502 identifies that it has learned, as per step 514 and such as based on the cached handover criteria, that VoNR is not supported by the 5G network 504. The UE 502 also identifies that it has learned, as per step 534 and such as based on the cached handover criteria, that the LTE signal for the 4G network 506 is weak. Based on this, at step 542, the UE 502 UE starts a ping-pong timer. While the ping-pong timer is running, the UE 502 does not perform IMS APN handover back to the cellular networks, such as networks 504 and 506. At step 544, upon expiration of the ping-pong timer, the UE 502 disables 5G NR and scans the LTE signal for a predetermined duration (such as one minute) to check LTE signal strength quality and stability. If the LTE signal strength is strong, the UE 502 continues to disable 5G NR and performs a VoWiFi to VOLTE handover to start using the LTE signal that now has better signal strength than was previously measured.

During step 544, the call is ongoing, and the UE 502 can continue scanning the LTE and WiFi signals for signal strength. For example, if LTE signal remains weak or is detected as being weak while the call is ongoing, the UE 502 re-enables VoNR and restarts the ping-pong timer to prevent handover so that the UE 502 continues to use VoWiFi and cannot attempt a handover back to 5G NR or 4G LTE. It will be understood that step 544 could occur any number of times based on the duration of the call and the length of the ping-pong timer. In various embodiments, the ping-pong timer can be set to various durations, such as one minute, a few minutes, a few hours, or a few days. Regardless of the duration of the ping-pong timer, when the call ends, at step 546, the UE 502 stops the ping-pong timer and performs a handover back to the 5G NR.

In this way, the UE 502 avoids the issues of entering a loop where the UE 502 performs a handover from VoWiFi back to VoNR, which then causes, because VoNR is not currently supported, repeated switching back to VOLTE and VoWiFi. Rather, since UE 502 establishes the ping-pong timer at step 542 to prevent handovers, the UE 502 can continue with VoWiFi during the duration of the timer, yet still switch to using LTE if the signal strength for LTE is detected as improved after expiry of the timer.

It will be understood that the LTE and WiFi signal strengths may change for a variety of reasons, such as if the user of the UE 502 is moving around in a location or moving to different locations. The cache of handover criteria can be cleared after the call ends, as well as at other points, such as each time the timer expires. In some embodiments, new handover criteria is cached at or before the start of each timer. The process 500 can be repeated for other call sessions. In this way, the process 500 provides for repeated handover avoidance by using dynamic configuration of blacklisting policies for RAT selection via the caching of cellular and WiFi handover criteria and via blacklisting fallback to the origin RAT (such as 5G) to avoid ping-ponging between cellular and WiFi networks. This reduces use of network resources and improves call quality such as reducing the likelihood of the call being dropped by avoiding switching to a network that does not support the call (like the 5G network 504).

Although FIGS. 5A and 5B illustrate one example of a handover loop avoidance process 500, various changes may be made to FIGS. 5A and 5B. For example, various components and functions in FIGS. 5A and 5B may be combined, further subdivided, replicated, or rearranged according to particular needs. Also, one or more additional components and functions may be included if needed or desired. In addition, while shown as a series of steps, various steps in FIGS. 5A and 5B could overlap, occur in parallel, occur in a different order, or occur any number of times (including zero times).

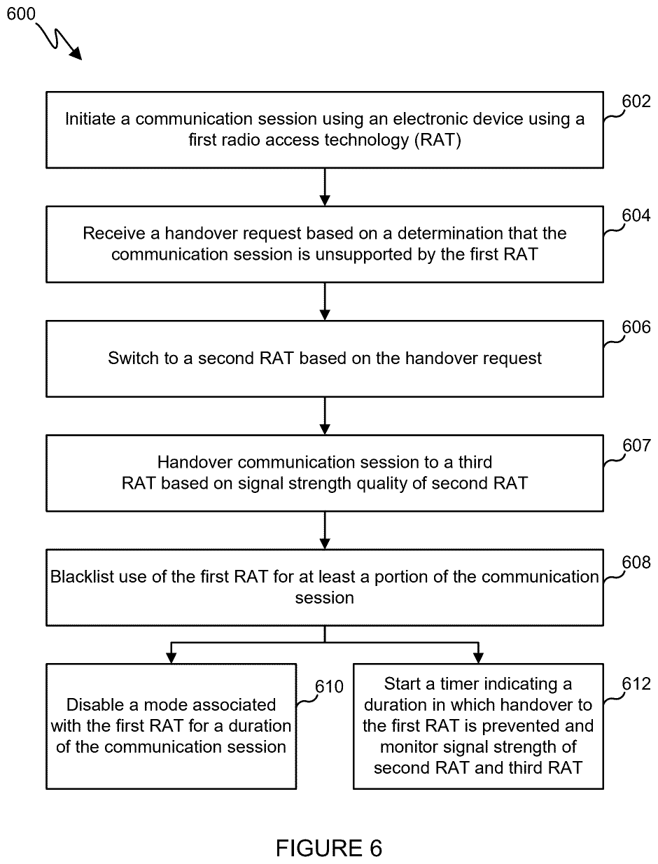

FIG. 6 illustrates an example method 600 for handover loop avoidance in accordance with this disclosure. For ease of explanation, the method 600 may be described as involving the use of a UE, such as the electronic device 300, in the wireless network 100 of FIG. 1. However, the method 600 may be used with any other suitable electronic device and in any other suitable system(s) and/or network(s).

At step 602, a communication session is initiated by an electronic device using a first RAT, such as 5G NR. This can include the processor 310 of the electronic device 300 executing steps 410-412 of FIG. 4A or steps 510-512 of FIG. 5A. At step 604, the electronic device receives a handover request based on a determination that the communication session is unsupported by the first RAT. This can include the processor 310 of the electronic device 300 executing step 414 of FIG. 4A or step 514 of FIG. 5A.

At step 606, the electronic device switches to using a second RAT, such as 4G LTE, based on the handover (EPS fallback) request. This can include the processor 310 of the electronic device 300 executing steps 416-422 of FIG. 4A or steps 516-522 of FIG. 5A. At step 607, the electronic device hands over the communication session to a third RAT based on the detected signal strength quality of the second RAT, such as if the signal strength of the second RAT is weak. As described in this disclosure, a handover from the second RAT to a third RAT, such as WiFi, can be performed based on one or more criteria, such as handover criteria. This can include the processor 310 of the electronic device 300 executing steps 424-438 of FIG. 4A or steps 524-538 of FIG. 5A. At step 608, the electronic device blacklists use of the first RAT for at least a portion of the communication session. In some embodiments, as shown at optional step 610, the blacklisting of the use of the first RAT includes disabling a mode associated with the first RAT for a duration of the communication session. This can include the processor 310 of the electronic device 300 executing steps 440-446 of FIG. 4B or steps 540-546 of FIG. 5B.

In various embodiments, as shown at optional step 612, the blacklisting of the use of the first RAT is also based on the one or more criteria. For example, the method 600 can include the electronic device determining, based on the one or more criteria, that a signal strength of the second RAT is below a first threshold and that a signal strength of the third RAT is above a second threshold. In various embodiments, the electronic device can cache the one or more criteria for a period of time. As also described in this disclosure, such as with respect to FIGS. 5A and 5B, the blacklisting of the use of the first RAT can include starting a timer indicating a duration in which handover to the first RAT is prevented.

In response to an expiry of the timer, the electronic device disables a mode associated with the first RAT and measures the signal strength of the second RAT. If the measured signal strength of the second RAT is above the first threshold, the electronic device continues the disabling of the mode associated with the first RAT and performs a handover from the third RAT to the second RAT. If the measured signal strength of the second RAT is below the first threshold, the electronic device reenables the mode associated with the first RAT and restarts the timer. This starting and restarting of the timer may occur any number of times during the communication session.

Although FIG. 6 illustrates one example of a method 600 for handover loop avoidance, various changes may be made to FIG. 6. For example, while shown as a series of steps, various steps in FIG. 6 could overlap, occur in parallel, occur in a different order, or occur any number of times (including zero times).

It should be noted that the functions shown in FIGS. 4 through 6 or described above can be implemented in an electronic device, server, or other device(s) in any suitable manner. For example, in some embodiments, at least some of the functions shown in FIGS. 4 through 6 or described above can be implemented or supported using one or more software applications or other software instructions that are executed by the processor 310 of the electronic device 300, or other device(s). In other embodiments, at least some of the functions shown in FIGS. 4 through 6 or described above can be implemented or supported using dedicated hardware components. In general, the functions shown in FIGS. 4 through 6 or described above can be performed using any suitable hardware or any suitable combination of hardware and software/firmware instructions. Also, the functions shown in FIGS. 4 through 6 or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
initiating a communication session by an electronic device using a first radio access technology (RAT);
receiving a handover request based on a determination that the communication session is unsupported by the first RAT;
switching to a second RAT based on the handover request; and
blacklisting use of the first RAT for at least a portion of the communication session.

2. The method of claim 1, further comprising:
performing a handover from the second RAT to a third RAT based on one or more criteria;
wherein the blacklisting of the use of the first RAT is based on the one or more criteria.

3. The method of claim 2, further comprising:
determining, based on the one or more criteria, that a signal strength of the second RAT is below a first threshold and that a signal strength of the third RAT is above a second threshold.

4. The method of claim 3, wherein:
the first RAT is Fifth Generation New Radio (5G NR);
the second RAT is Fourth Generation Long-Term Evolution (4G LTE); and
the third RAT is WiFi.

5. The method of claim 3, further comprising:
caching the one or more criteria for a period of time.

6. The method of claim 3, wherein the blacklisting of the use of the first RAT includes:
starting a timer indicating a duration in which handover to the first RAT is prevented;
in response to an expiry of the timer, disabling a mode associated with the first RAT and measuring the signal strength of the second RAT; and
one of:
if the measured signal strength of the second RAT is above the first threshold, continuing the disabling of the mode associated with the first RAT and performing a handover from the third RAT to the second RAT; or
if the measured signal strength of the second RAT is below the first threshold, reenabling the mode associated with the first RAT and restarting the timer.

7. The method of claim 1, wherein the blacklisting of the use of the first RAT includes disabling a mode associated with the first RAT for a duration of the communication session.

8. An electronic device comprising:
at least one processing device configured to:
initiate a communication session using a first radio access technology (RAT);
receive a handover request based on a determination that the communication session is unsupported by the first RAT;
switch to a second RAT based on the handover request; and
blacklist use of the first RAT for at least a portion of the communication session.

9. The electronic device of claim 8, wherein:
the at least one processing device is further configured to perform a handover from the second RAT to a third RAT based on one or more criteria; and
the blacklisting of the use of the first RAT is based on the one or more criteria.

10. The electronic device of claim 9, wherein the at least one processing device is further configured to determine, based on the one or more criteria, that a signal strength of the second RAT is below a first threshold and that a signal strength of the third RAT is above a second threshold.

11. The electronic device of claim 10, wherein:
the first RAT is Fifth Generation New Radio (5G NR);
the second RAT is Fourth Generation Long-Term Evolution (4G LTE); and
the third RAT is WiFi.

12. The electronic device of claim 10, wherein the at least one processing device is further configured to cache the one or more criteria for a period of time.

13. The electronic device of claim 10, wherein, to blacklist the use of the first RAT, the at least one processing device is configured to:
start a timer indicating a duration in which handover to the first RAT is prevented;
in response to an expiry of the timer, disable a mode associated with the first RAT and measuring the signal strength of the second RAT; and
one of:
if the measured signal strength of the second RAT is above the first threshold, continue to disable the mode associated with the first RAT and perform a handover from the third RAT to the second RAT; or
if the measured signal strength of the second RAT is below the first threshold, reenable the mode associated with the first RAT and restart the timer.

14. The electronic device of claim 8, wherein, to blacklist the use of the first RAT, the at least one processing device is configured to disable a mode associated with the first RAT for a duration of the communication session.

15. A non-transitory machine readable medium containing instructions that when executed cause at least one processor of an electronic device to:
initiate a communication session using a first radio access technology (RAT);
receive a handover request based on a determination that the communication session is unsupported by the first RAT;
switch to a second RAT based on the handover request; and
blacklist use of the first RAT for at least a portion of the communication session.

16. The non-transitory machine readable medium of claim 15, further containing instructions that when executed cause the at least one processor of the electronic device to perform a handover from the second RAT to a third RAT based on one or more criteria;
wherein the blacklisting of the use of the first RAT is based on the one or more criteria.

17. The non-transitory machine readable medium of claim 16, further containing instructions that when executed cause the at least one processor of the electronic device to determine, based on the one or more criteria, that a signal strength of the second RAT is below a first threshold and that a signal strength of the third RAT is above a second threshold.

18. The non-transitory machine readable medium of claim 17, further containing instructions that when executed cause the at least one processor of the electronic device to cache the one or more criteria for a period of time.

19. The non-transitory machine readable medium of claim 17, wherein the instructions that when executed cause the at least one processor to blacklist the use of the first RAT include:
instructions that when executed cause the at least one processor to start a timer indicating a duration in which handover to the first RAT is prevented;
instructions that when executed cause the at least one processor to, in response to an expiry of the timer, disable a mode associated with the first RAT and measuring the signal strength of the second RAT; and
instructions that when executed cause the at least one processor to one of:
if the measured signal strength of the second RAT is above the first threshold, continue to disable the mode associated with the first RAT and perform a handover from the third RAT to the second RAT; or
if the measured signal strength of the second RAT is below the first threshold, reenable the mode associated with the first RAT and restart the timer.

20. The non-transitory machine readable medium of claim 15, wherein the instructions that when executed cause the at least one processor to blacklist the use of the first RAT include:
instructions that when executed cause the at least one processor to disable a mode associated with the first RAT for a duration of the communication session.
